(19) United States
(12) Patent Application Publication
(10) Pub. No.: US 2007/0183388 A1
(43) Pub. Date: Aug. 9, 2007

(54) Method for performing measurements by a mobile station of a radio-communication system, corresponding mobile station, and unit for a radio-communication system

(76) Inventors: Volker Breuer, Botzow (DE); Frederic Charpentier, Berlin (DE); Frank Lamprecht, Berlin (DE)

Correspondence Address: STAAS & HALSEY LLP, SUITE 700, 1201 NEW YORK AVENUE, N.W., WASHINGTON, DC, 20005, US

(21) Appl. No.: 11/579,618

(22) PCT Filed: Apr. 5, 2005
(86) PCT No.: PCT/EP2005/51837

§ 371 Date: Nov. 6, 2006

(51) Int. Cl. H04J 3/00

(52) U.S. Cl. 370/345

(57) ABSTRACT

A method performs measurements by a mobile station of a radio communication system. According to said method, the mobile station receives data via a first channel. Said mobile station temporarily interrupts the reception of the data, in order to perform measurements on at least one second channel. The interruption of the reception takes place according to a correctability of errors occurring during the data transmission via the first channel.

### CROSS REFERENCE TO RELATED APPLICATIONS

This application is based on and hereby claims priority to PCT National Phase Application No. PCT/EP2005/051837 filed on Apr. 25, 2004 and German Patent Application No. 10 2004 022 147.2, filed May 5, 2004, the contents of which are hereby incorporated by reference.

### BACKGROUND

The invention relates to a method for the performing of measurements by a mobile station of a radio-communication system and to a corresponding mobile station and a unit for a radio-communication system.

In radio-communication systems, communication between participating stations takes place by electromagnetic waves transmitted over an air interface. Depending on the specific radio-communication system, individual or all stations in the system can be stationary or mobile. Mobile-radio systems are a type of radio-communication system having mobile stations. There are mobile-radio systems conforming to different mobile-radio standards. What are known are, for example, mobile-radio standards of the second generation such as, for instance, IS-95 and GSM (Global System of Mobile communication) and of the third generation such as, for instance, CDMA2000 and UMTS (Universal Mobile Telecommunication System).

In the FDD (Frequency Division Duplex) variant of the UMTS standard, mobile stations all share the same radio channel in what is termed the Cell-FACH (Fast Access Channel) state. Data is transmitted to the various mobile stations using code-division multiplexing and time-division multiplexing. For cost reasons, a mobile station usually has just one high-frequency receiver that has to be set to receive in the respective frequency band. To be able, in the Cell-FACH state, to perform measurements on a channel in a frequency band different from that of the channel currently being received (this is necessary, for example, for receiving a channel of another radio cell belonging to the same mobile-radio system, for what is termed interfrequency measuring, or belonging to another mobile-radio system, for what is termed intersystem measuring), the mobile station's receiver requires certain periods of time during which it can be switched over to the respective other frequency band. Said periods of time are referred to in the UMTS-FDD standard as “measurement occasions”. The “measurement occasions” concept provides for interrupting data transmissions from a base station on a channel to a mobile station for previously specified periods of time. Said measurement occasions are specified by the mobile-radio network taking account of characteristics that are specific to mobile stations such as, for instance, the mobile station's identification number, and the transmission of data on the channel to which the measurement occasions are assigned is organized accordingly. That insures that no data will have to be received on the corresponding channel by the mobile station while it is performing interfrequency or intersystem measurements. A loss of data otherwise transmitted during the measurement occasions is thereby avoided.

Provision has been made for introducing what are termed MBMS (Multimedia Broadcast Multicast Service) services in mobile-radio systems such as, for example, GSM and UMTS. During what is termed an MBMS session a base station transmits data simultaneously to all mobile users participating in said session over a single, shared channel. Mobile stations can, according to the UMTS-FDD standard, also be in the Cell-FACH state during an MBMS session. It has been provided for mobile stations of said type to take the measurement occasions into account regardless of whether or not said stations are participating in an MBMS session so that they can perform the necessary measurements on other channels during said periods of time. However, in contrast to when individual data is transmitted to a single mobile station that is in the Cell-FACH state, the loss of data transmitted on the respective channel can only be avoided at very great expense during an MBMS session. That is because it would be too expensive to synchronize the different measurement occasions for all mobile stations participating in an MBMS session. That means the measurement occasions for the various participating mobile stations begin and end at different times so that the transmitting of data during an MBMS session would have to be frequently interrupted to avoid data losses at the individual mobile stations. The transmission capacity and advantages of point-to-multipoint transmission would, though, be badly affected as a result. For that reason, a solution seems preferable according to which data transmission will not be interrupted during an MBMS session despite the provision, at the same time, of measurement occasions for mobile stations participating in the session.

### SUMMARY

One possible object of the invention is to facilitate an improvement in the operation of a mobile station for a radio-communication system in which the mobile station receives data over a first channel data and the mobile station temporarily interrupts data reception in order to perform measurements on at least one second channel.

The inventors propose a method for the performing of measurements by a mobile station of a radio-communication system the mobile station receives data over a first channel. The mobile station temporarily interrupts data reception in order to perform measurements on at least one second channel. Said reception is therein interrupted depending on a correctability of errors occurring while data is being transmitted over the first channel.

The inventors also propose a method for causing interruptions in the reception by a radio-communication system's mobile station of data transmitted over a first channel, with said interruptions serving for the mobile station to perform measurements on at least one second channel. The method provides for said interruptions in reception to be caused depending on a correctability of errors occurring while data is being transmitted over the first channel. Data can therein also be transmitted during said interruptions, in particularly continuously.

Although applicable to any radio-communication systems having mobile stations, the method is especially suitable for use in mobile-radio systems. It can therein be applied to mobile-radio systems conforming to any standards. Having reception interrupted depending on error correctability can be realized such that, for example, interruptions will take place only if specific requirements placed on correctability have been met through, for instance, reaching a specific error-tolerance threshold during data transmission. Dependence on error correctability can also include, for example, in specifying the scheduling, duration, or frequency of interruptions in reception as a function of said correctability. It will be expedient for, say, the duration of the interruption(s) or the frequency thereof to increase as error correctability during data transmission increases.

The method is especially suitable for use in radio-communication systems in which data continues being transmitted over the first channel during the interruption in reception by the mobile station. That is because, with interruption in reception taking place depending on error correctability during data transmission, what can be achieved is that the data transmitted over the first channel and not received by the mobile station during said interruption will be treated in the same way as transmission errors occurring during data transmission. This means that the missing data (or at least a part thereof) can, within the scope of the possibilities for error correcting available to the data-transmission method used, be corrected or, as the case may be, reconstituted on the receive side like transmission errors, so that the non-reception of said data will have no impact. The better error correctability during data transmission over the first channel is, the more probable it will be that data not received during the interruption in reception by the mobile station can be reconstituted by relevant error-protection mechanisms of the transmission protocol used. Better error correctability during data transmission will thus enable longer or more frequent interruptions in reception to be applied than when error correctability is poorer. Since the application of interruptions serves to perform measurements on the second channel, it will thus also be possible to perform more measurements when error correctability during data transmission is better.

An embodiment provides for the data transmitted over the first channel to be broadcast-service data that can be received simultaneously by a multiplicity of mobile stations of the radio-communication system. The service can in particular be an MBMS service.

In the case of a broadcast service, which is received by a plurality of mobile stations, the method makes it possible to apply interruptions serving measuring purposes for the mobile stations on a non-synchronized basis, which is to say to apply said interruptions at any time instants independently of each other. The reason for this is that each mobile station is able individually to (at least partially) reconstitute the data not received by it during the interruptions.

The measurements on the channel can serve, for example, to prepare for a change from the first to the second channel (what is termed “cell reselection”).

According to an embodiment the first channel is located in a first frequency band and the second channel in a second frequency band. Since the measurements on the second channel are performed during the interruptions in reception on the first channel, the same high-frequency receiver of the mobile station can be used for both purposes, said receiver needing only to be set in each case to the relevant frequency band.

According to a further embodiment, the first and second channel have been assigned to different radio cells of the same radio-communication system or of different such systems.

According to a development the correctability of errors for the data transmission over the first channel is determined on the basis of

a coding rate of the first channel and/or

a channel-coding method used for the first channel and/or

error-protection mechanisms of higher layers of a transmission protocol for the transmission of data over the first channel.

A channel's coding rate denotes the ratio of transmitted useful data to the overall data volume, with the overall data volume being the useful data plus any other data, including data serving to perform error correcting on the transmitted data.

Examples of different channel-coding methods include turbo coding and convolutional coding. These two coding methods can, with the coding rate being the same, exhibit different behaviors in terms of the error correctability of data transmitted using them.

In particular what is termed interleaving (interleaving of the data being transmitted with an interleaving depth corresponding to the length of a transmission period, what is termed the Transmission Time Interval, TTI) or what is termed outer coding (interleaving of the data being transmitted with an interleaving depth corresponding to the length of a plurality of consecutive TTIs) can be considered as error-protection mechanisms of higher layers of the transmission protocol used.

According to a development the mobile station and/or a device of the radio-communication system ascertain(s) at least one parameter of the interruptions on the basis of the correctability of errors for the data transmission over the first channel. The parameter of the interruptions can relate to, for example

the frequency of the interruptions per unit of time and/or

time instants for applying the interruptions and/or

time portions of the interruptions per unit of time.

According to a development, information from which the at least one parameter is deducible is transmitted to the mobile station by the device of the radio-communication system. That means the parameter is determined wholly or partly on the network side.

According to a development the parameter relates to a specific amount of interruptions and describes a subset of said amount. In an embodiment, said amount of interruptions can therein be formed by what are termed measurement occasions according to the UMTS standard. Said measurement occasions can therein be favorably ascertained in the same way, as has hitherto been provided according to the UMTS standard. It will then be possible for the parameter to indicate only a percentage, for example, and for the mobile station, as a function of a percentage of said type, to use only a corresponding portion of the measurement occasions ascertained in the conventional manner in the form of interruptions in reception on the first channel.

According to a development the correctability of errors occurring during transmission over the first channel is matched as a function of an intended change in the number and/or frequency and/or duration of the interruptions. That means, for example, that the error correctability will be purposely improved in the case of a desired lengthening of the period of time available for the measurements on the second channel so that, during the interruptions in reception on the first channel that are to be applied for the measurements, at least a part of the data not received over the first channel during the interruptions can be reconstituted. Enhancing of the error correctability for that purpose can therein, for example, take place only temporarily; it can be reduced again if there is less need to perform measurements later. An enhancement in error correctability can be achieved by, for example, selecting a better channel-coding method or a lower coding rate or improved error-protection mechanisms of a higher protocol layer of the transmission protocol for the data transmission over the first channel.

The mobile station for a radio-communication system has

a receiver unit for receiving data over a first channel,

an interruption unit for temporarily interrupting the reception of the data, and

a measurement unit for performing measurements on at least one second channel during the interruptions, with said interruption unit interrupting the reception applying corresponding interruptions depending on a correctability of errors occurring while data is being transmitted over the first channel.

The unit for a radio-communication system has an interruption unit for causing interruptions in reception by a mobile station of the radio-communication system of data transmitted over a first channel, with said interruptions serving for the mobile station to perform measurements on at least one second channel. Said interruption unit for causing the interruptions cause them depending on a correctability of errors occurring while data is being transmitted over the first channel.

### BRIEF DESCRIPTION OF THE DRAWINGS

These and other objects and advantages will become more apparent and more readily appreciated from the following description of the preferred embodiments, taken in conjunction with the accompanying drawings of which:

FIG. 1 shows a section of a radio-communication system in which a mobile station receives data over two channels,

FIG. 2 shows details of data transmitted over the two channels shown in FIG. 1, and

FIG. 3 shows a further exemplary embodiment of data transmitted over one of the channels shown in FIG. 1.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

Although the method can be applied to any radio-communication systems having mobile stations and hence also to any mobile-radio systems, it will be explained below using a UMTS-FDD mobile-radio system.

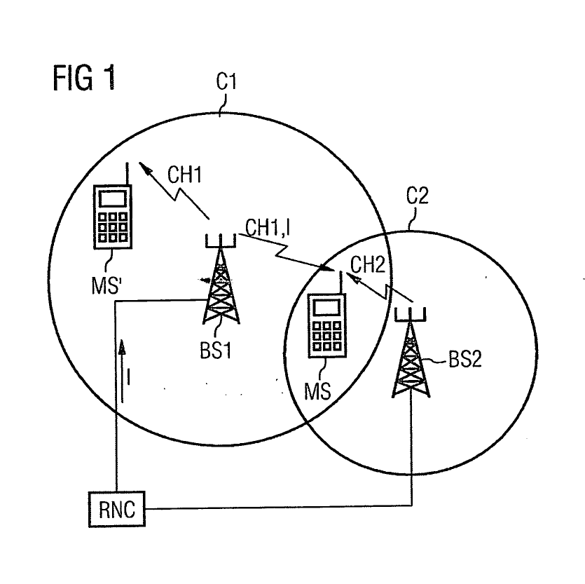

FIG. 1 shows a section of a cellular mobile-radio system. Only two radio cells C1, C2 are shown. Each radio cell C1, C2 is served by a base station BS1, BS2. Located in a transitional area between the two radio cells C1, C2 is a mobile station MS. It receives data over a channel CH1 from the first base station BS1 and over a second channel CH2 from the second base station BS2. The data of the first channel CH1 is broadcast from the first base station BS1 and can, inter alia, be received by further mobile stations MS′. The base stations BS1, BS2 are connected to a common base-station controller RNC, with its also being possible in the case of other exemplary embodiments to assign different base-station controllers to both base stations.

The data transmitted over the first channel CH1 shown in FIG. 1 is assigned to an MBMS service. The second channel CH2 of the second base station BS2 is an organization channel, specifically a BCCH (Broadcast Control Channel) of the second base station BS2. The mobile station MS initially receives the MBMS data of the first channel CH1. Because the mobile station MS, though indeed located within the first radio cell C1, is actually in the transitional area toward the second radio cell C2, it is desirable for it to perform measurements on the second channel CH2 in order to ascertain said channel's reception quality. The cited measurements can, in other exemplary embodiments, serve also to measure other organization channels of other base stations (not shown in FIG. 1) alongside the second channel CH2. The results of said measurements serve, in a manner known to a person skilled in the relevant art, to prepare for a change of channel or, as the case may be, cell for the mobile station MS (what is termed handover or cell reselection). The channels CH1, CH2 are each operated in different frequency bands as the two base stations BS1, BS2 have been assigned different frequency bands to avoid mutual interference. However, in this exemplary embodiment the mobile station MS employs one and the same receiver for receiving signals over the two channels CH1, CH2. That can, of course, only take place sequentially, with the receiver being set to the respectively applicable frequency band.

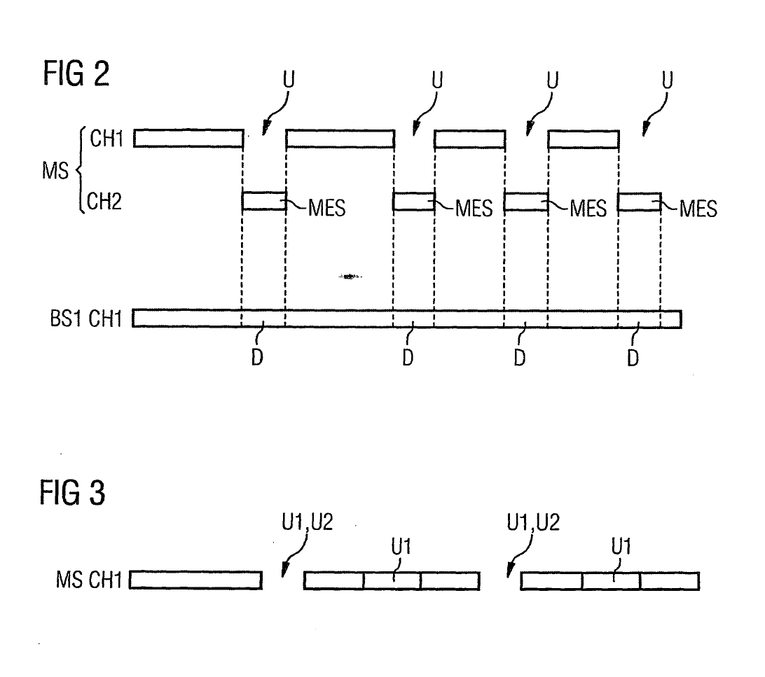

In this exemplary embodiment the base-station controller RNC ascertains information I from which parameters of interruptions requiring to be applied by the mobile station MS are deducible. The base-station controller RNC conveys said information I to the mobile station MS by the first base station BS1. A special control channel located between the first base station BS1 and the mobile station MS and assigned to the MBMS service is used for this. The base-station controller RNC ascertains said information I as a function of errors possibly occurring during the correctability of the data transmission over the first channel CH1. Specifically, the mobile station MS is instructed initially to apply few interruptions for measuring purposes and, later, to increase the frequency of said interruptions, as will be explained below with the aid of FIG. 2. The frequency of the interruptions is therein increased when, in preparation therefor, the error correctability for the data transmission over the first channel CH1 has been increased by, for example, lowering the coding rate for the first channel CH1 by introducing additional error-correction data.

Shown in the bottom section of FIG. 2 for the exemplary embodiment being considered is the emission of the MBMS data over the first channel CH1 by the first base station BS1. That takes place continuously over the period of time considered. Shown in the first row in FIG. 2 is the reception by the mobile station MS of the data transmitted over the first channel CH1. Said reception exhibits periodic interruptions U applied by the mobile station MS as a function of the information I conveyed by the base-station controller RNC and of the parameters deduced from said information for the interruptions U. During the interruptions U in reception on the first channel CH1, the mobile station MS changes reception over to the second channel CH2 of the second base station BS2, there performing measurements MES whose results it reports in a manner known to a person skilled in the relevant art to the first base station BS1. The results of said measurements MES serve in the radio-communication system to decide whether handover to a channel of the second base station BS2 should take place or not.

From FIG. 2 it can be seen that the periods of time between the interruptions U as a function of the information I are at first longer than between the three interruptions shown last in FIG. 2. The reason for this is that the error correctability during data transmission over the first channel CH1 was, in the manner described above, increased after the first interruption U shown in FIG. 2 by lowing the coding rate.

Shown in the last row in FIG. 2 are also the data D emitted over the first channel CH1 while the mobile station MS is interrupting its reception. Said data will consequently not be received by the mobile station. So that this data does not have to be foregone completely, using the error-correction methods available to it the mobile station MS will attempt to reconstitute as much as possible of said data D. That can be done with promising prospects particularly when the data transmitted over the first channel CH1 has undergone especially intense interleaving. That is because, depending of the number of error-correction bits provided, interleaving also allows larger data blocks to be reconstituted because the individual useful-data bits transmitted within said data blocks are not adjacent to each other prior to interleaving or, as the case may be, after de-interleaving.

The interruptions U, shown in FIG. 2, in the reception of data over the first channel CH1 by the mobile station MS can be conveyed via the information I in, for example, the following manner: The base-station controller signals the number of interruptions U to be applied per time frame and, where applicable, also their respective duration and/or scheduling to the mobile station MS via the information I. It is, though, also possible for the mobile station MS to ascertain a part or all of the parameters necessary for specifying the interruptions U independently using pre-specified algorithms, but always depending on the respectively insured error correctability.

It will, of course, be unnecessary to transmit relevant information I from the base-station controller RNC to the mobile station MS if the mobile station MS itself ascertains all the parameters necessary for determining the interruptions U, U2.

FIG. 3 shows, for another exemplary embodiment, the reception by the mobile station MS of the data transmitted over the first channel CH1. In the case of the section of the data transmission shown in FIG. 3 there was no change in the error correctability of the data transmission over the first channel CH1 so that the number of interruptions is not changed. What is shown is a first amount of interruptions U1, which are what are termed measurement occasions according to the UMTS standard and are ascertained by the mobile station MS in the manner provided according to the UMTS standard. That is done by taking three parameters into account:

1. The amount of measurement occasions U1 is determined according to the UMTS standard by the longest what is termed Transmission Time Interval (TTI) on the SCCPCH (Secondary Control Physical Channel).

2. The frequency of measurement occasions U1 is determined by a parameter k conveyed to the mobile station MS by the base-station controller RNC.

3. The scheduling of measurement occasions U1 is thereafter determined by the mobile station MS on the basis of its individual identification coding.

The parameters k already provided according to the UMTS standard can, for example, be transmitted to the mobile station MS jointly with the information I shown in FIG. 1. In the exemplary embodiment according to FIG. 3 the information I contains only a percentage, in the present case 50%, indicating what portion of the measurement occasions U1, which are customarily provided only for measurements in the Cell-FACH state (no transmission to the respective mobile station during the measurement occasions assigned to it), is to be used for the interruptions U2 on the first channel CH1 of the MBMS service. Said percentage of 50% is transmitted via the information I to the mobile station MS as a parameter. The mobile station MS according to FIG. 3 will consequently use only 50% of the measurement occasions U1 it has ascertained in the aforementioned manner, so only every other measurement occasion U1, for applying interruptions U2. Only during said interruptions U2 will it perform the measurements MES, already described with the aid of FIG. 2, on the second channel CH2.

In another embodiment all measurement occasion U1 could instead be used for applying the interruptions U2, but with only 50% of their length. The resulting advantage is that less data will in each case not be received during the interruptions applied with shorter duration (but with greater frequency). It would, supposing the same error correctability, thus be possible to correct more of said data.

What can be achieved through applying the interruptions U, U2 as a function of error correctability is that, despite the application of said interruptions to the reception of a continuous data transmission in the form of, for example, MBMS data over the first channel CH1, the transmission quality or, as the case may be, quality of service will attain specific minimum values notwithstanding the interruptions. The transmission quality or, as the case may be, quality of service can be ascertained by, for example, determining the block error rate BLER.

In the exemplary embodiment according to FIG. 3, fewer interruptions U2 take place than are provided for measurement occasions for mobile stations in the Cell-FACH state. A compromise is hereby achieved between, on the one hand, the need to be able at all to perform measurements for, for instance, preparing for changing between radio cells and, on the other, the necessity to keep the interruptions U, U2 during reception of a continuous service, which is what, for example, MBMS services are, sufficiently slight for data losses D occurring during said interruptions do not impact too negatively, specifically by compensating at least a part of said data losses D by the existing error-correction mechanisms for the selected data transmission over the first channel CH1.

The information I, shown in FIG. 1, which is exchanged between the base-station controller RNS and the mobile station MS, is transmitted over higher layers of the transmission protocol used.

The parameters of the interruptions U, U2 are determined in such a way that, as a function of the available error correctability of the data transmission, a desired quality of service will as far as possible not be undershot, meaning that the data loss D occurring during reception by the first channel CH1 as a result of performing the measurements MES on the second channel CH2 or, as the case may be, applying the interruptions U, U2 is controlled in such a way as to be able to be compensated under the transmission conditions to be expected (meaning without there being any particularly severe additional error effects) by the available error-correction mechanisms. However, no particularly serious error effects are to be expected when MBMS services are being used as these are high-rate data services employed, as a rule, only when the user of the mobile station MS is moving relatively little or not at all, so that major changes in transmission quality while transmission is in progress due, for example, to fading will occur relatively seldom.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-15. (canceled)

16. A method for performing measurements by a mobile station of a radio-communication system, comprising:
receiving first data at the mobile station over a first channel, which first data is relatively difficult to reconstruct if interrupted;
receiving second data at the mobile station over the first channel, which second data is relatively easy to reconstruct if interrupted;
determining whether the mobile station is receiving the first data or the second data;
temporarily interrupting reception of the first data over the first channel in order to perform measurements on a second channel;
temporarily interrupting reception of the second data over the first channel in order to perform measurements on the second channel, the data being interrupted such that less interruption occurs to the first data than to the second data.

17. A method for performing measurements by a mobile station of a radio-communication system, comprising:
receiving data at the mobile station over a first channel;
temporarily interrupting reception of the data in order to perform measurements on a second channel; and
varying interruption in reception depending on a correctability of errors occurring while data is being transmitted over the first channel.

18. The method as claimed in claim 17, wherein:
data continues being transmitted over the first channel during the interruption in reception.

19. The method as claimed in claim 18, wherein:
the data transmitted over the first channel and not received by the mobile station during the interruption is treated in the same way as transmission errors occurring during data transmission.

20. The method as claimed in claim 17, wherein the correctability of errors is determined on the basis of:
a coding rate of the first channel and/or
a channel-coding method used for the first channel and/or
error-protection mechanisms of higher layers of a transmission protocol for the transmission of data over the first channel.

21. The method as claimed in claim 17, wherein:
the mobile station and/or a device of the radio-communication system sets at least one parameter to vary interruption depending on the correctability of errors.

22. The method as claimed in claim 21, wherein the at least one parameter relates to:
frequency of interruptions per unit of time and/or
time instants for applying the interruptions and/or
length of the interruptions per unit of time.

23. The method as claimed in claim 21, wherein:
information from which the at least one parameter is deducible is transmitted to the mobile station by the device of the radio-communication system.

24. The method as claimed in claim 21, wherein:
the parameter relates to a specific amount of interruptions and describes what portion of said interruptions will be used for measurements of the second channel.

25. The method as claimed in claim 24, wherein:
the specific amount of interruptions relates to measurement occasions according to the UMTS standard.

26. The method as claimed in claim 17, wherein:
the correctability of errors increases or decreases respectively with increases or decreases in number and/or frequency and/or duration of the interruptions.

27. The method as claimed in claim 17, wherein:
the first channel is located in a first frequency band and the second channel is located in a second frequency band.

28. The method as claimed in claim 17, wherein:
the first channel and the second channel are assigned to different radio cells of the same radio-communication system or of different such systems.

29. The method as claimed in claim 19, wherein the correctability of errors is determined on the basis of:
a coding rate of the first channel and/or
a channel-coding method used for the first channel and/or
error-protection mechanisms of higher layers of a transmission protocol for the transmission of data over the first channel.

30. The method as claimed in claim 29, wherein:
the mobile station and/or a device of the radio-communication system sets at least one parameter to vary interruption depending on the correctability of errors.

31. The method as claimed in claim 30, wherein the at least one parameter relates to:
frequency of interruptions per unit of time and/or
time instants for applying the interruptions and/or
length of the interruptions per unit of time.

32. The method as claimed in claim 31, wherein:
information from which the at least one parameter is deducible is transmitted to the mobile station by the device of the radio-communication system.

33. The method as claimed in claim 32, wherein:
the parameter relates to a specific amount of interruptions and describes what portion of said interruptions will be used for measurements of the second channel.

34. A mobile station for a radio-communication system, comprising:
a receiver unit to receive data over a first channel;
an interruption unit to temporarily interrupt reception of the data;
a measurement unit to perform measurements on at least one second channel during interruptions in reception of the data; and
wherein the interruptions are varied depending on a correctability of errors occurring while data is being transmitted over the first channel.

35. A unit for a radio-communication system, comprising:
an interruption unit to cause interruptions in reception by a mobile station of the radio-communication system, of data transmitted over a first channel, with said interruptions serving for the mobile station to perform measurements on at least one second channel;
a variance unit to vary said interruptions based on a correctability of errors occurring while data is being transmitted over the first channel.
